(19) United States
(12) Patent Application Publication
(10) Pub. No.: US 2004/0201447 A1
(43) Pub. Date: Oct. 14, 2004

(54) Thin-film resistor device

(76) Inventor: Marvin Glenn Wong, Woodland Park, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/413,798

(22) Filed: Apr. 14, 2003

(51) Int. Cl. H01C 1/012

(52) U.S. Cl. 338/309

(57) ABSTRACT

A thin-film resistor device is disclosed. In one embodiment, the device comprises a substrate supporting first and second contacts. A compliant material is deposited on the substrate. A thin-film resistor is deposited on the compliant material and coupled between the first and second contacts.

### BACKGROUND OF THE INVENTION

Thin film resistors can be used to generate heat. When heated, some of these resistors reach high temperatures (e.g., 400-600° Celsius). In some environments, the resistors are temperature cycled repeatedly. During the ramp-up portions of their temperature cycles, the resistors often heat much more quickly than the substrates on which they are deposited, thereby subjecting the resistors to compressive stresses. In a similar fashion, the resistors are subjected to tensile stresses during the ramp-down portions of their temperature cycles (because the resistors often cool much more quickly than the substrates on which they are deposited). These repeated stresses fatigue the resistors, and sometimes cause the resistors to crack.

### SUMMARY OF THE INVENTION

In one embodiment, a device including a thin-film resistor is disclosed. The device comprises a substrate that supports first and second contacts. A compliant material is deposited on the substrate. The thin-film resistor is deposited on the compliant material and coupled between the first and second contacts.

### BRIEF DESCRIPTION OF THE DRAWINGS

Illustrative embodiments of the invention are illustrated in the drawings in which:

FIG. 1 illustrates an exemplary plan view of a thin-film resistor device;

FIG. 2 is an elevation view of the device shown in FIG. 1;

FIG. 3 illustrates a method for producing the device of FIG. 1;

FIG. 4 is a plan view illustrating a second exemplary embodiment of a thin-film resistor device;

FIG. 5 is an elevation view of the device shown in FIG. 4;

FIG. 6 is an elevation view of a third exemplary embodiment of a thin-film resistor device;

FIG. 7 illustrates a method for producing the device of FIG. 6;

FIG. 8 is an exemplary plan view of a substrate for a switch including a thin-film resistor device;

FIG. 9 illustrates an elevation view of the FIG. 8 substrate;

FIG. 10 illustrates a first exemplary embodiment of a switch comprising a thin-film resistor heater; and

FIG. 11 illustrates a second exemplary embodiment of a switch comprising a thin-film resistor heater.

### DETAILED DESCRIPTION

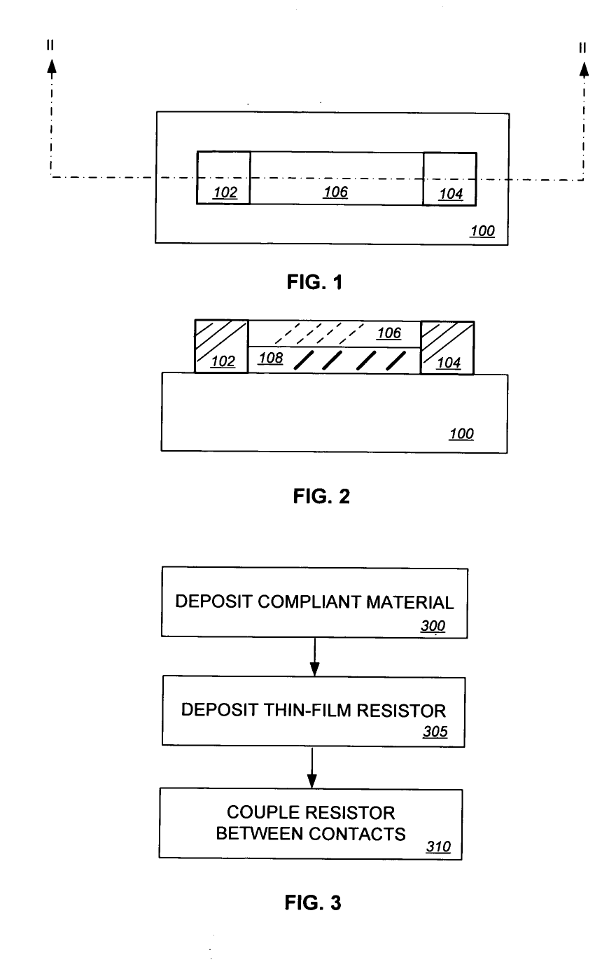

A device that may be used to reduce resistor cracking is illustrated in FIGS. 1 & 2. As illustrated in FIG. 3, the device may be produced by first depositing 300 a compliant material 108 on a substrate 100. By way of example, the compliant material 108 may be deposited on the substrate by spin-coating or patterning. Other methods may also be used to deposit the compliant material on the substrate. The compliant material 108 may be any flexible material that has good heat resistance, such as polyimide.

Next, a thin-film resistor 106 is deposited 305 on the compliant material 108. For example, the thin-film resistor may be deposited on the compliant material by spin-coating, patterning, or any other method. In one embodiment, the thin-film resistor 106 may be a ceramic resistor, such as tantalum nitride. The thin-film resistor 106 may also be a metallic resistor, such as molybdenum or tungsten. After the resistor is deposited on the compliant material, it is coupled 310 between a first contact 102 and a second contact 104. It should be appreciated that the resistor may also be coupled between the contacts 102 and 104 at about the same time as it is being deposited on the compliant material.

In one embodiment, the thin-film resistor 106 may be used to generate heat. As the resistor heats up and expands, it is subject to compressive stress caused by the compliant material 108 and the two contacts 102, 104 it is coupled to. However, because the compliant material is flexible, the compressive stress is less than it would be without the compliant layer. As the local region in the substrate 100 heats up by conduction and expands, the compressive stress in the resistor is reduced even further.

After the resistor 106 turns off and starts to cool, it contracts. Because the local region in the substrate 100 is still hot and expanded, the resistor is subject to tensile stress. However, the compliant layer 108 minimizes the tensile stress because the flexibility of the material lets it contort, allowing the resistor and the substrate to apply different expansive and compressive forces to it.

In another embodiment, the composition of the thin-film resistor 106 and the compliant material 108 may be selected so that the deposition 305 of the resistor on the compliant material results in the resistor forming a weak bond with the compliant material. As the resistor heats up, the stresses from the differing expansion of the resistor 106 and the compliant material 108 may cause the resistor to partially or completely delaminate from the compliant layer, thus reducing the compressive stress applied to the resistor. While the resistor is cooling and contracting, the tensile stress is also reduced because the delamination from the compliant layer gives the resistor more independence from the expanding force applied by the hot substrate.

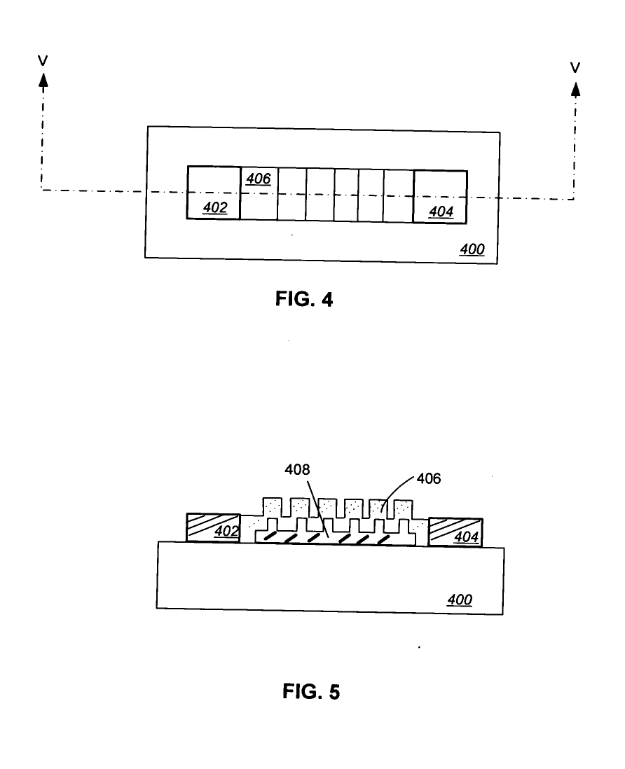

A second exemplary embodiment of a device including a thin-film resistor 406 is shown in FIGS. 4 and 5. A compliant material 408, such as polyimide, is deposited on a substrate 400. The compliant material is deposited in a manner that causes the compliant material to be corrugated. In one embodiment, this may be done by depositing a layer of compliant material, depositing and patterning a mask layer, partially etching the compliant material through the mask, and then removing the mask layer. Alternatively, two or more layers of compliant material may be deposited and patterned. The thin-film resistor 406 is then deposited on the compliant material and coupled between a first contact 402 and a second contact 404. By way of example, the thin-film resistor may be a ceramic resistor, (e.g., tantalum nitride) or a metal (e.g., molybdenum or tungsten).

In one embodiment, the thin-film resistor 406 is used to generate heat. As the thin-film resistor starts to heat up and expand, the corrugation of the compliant layer 408 can contract, similar to an accordion. Thus, the compressive stress on the thin-film resistor is reduced. When the resistor is turned off and starts to cool, the corrugation of the compliant layer can expand similar to an accordion, thus reducing the tensile stress caused by the still hot substrate 400. The corrugation of the compliant material also reduces the stresses at the ends of the resistor.

In an alternate embodiment, the composition of the thin-film resistor 406 and the compliant layer 408 may be selected so that the resistor forms a weak-bond with the compliant layer. As the resistor starts to heat up, the different forces applied by the expanding resistor and the substrate 400 may cause the resistor to partially or completely delaminate from the compliant layer. The delamination of the resistor gives it greater freedom from the compressive and tensile stresses normally applied to it during the heating and cooling cycle.

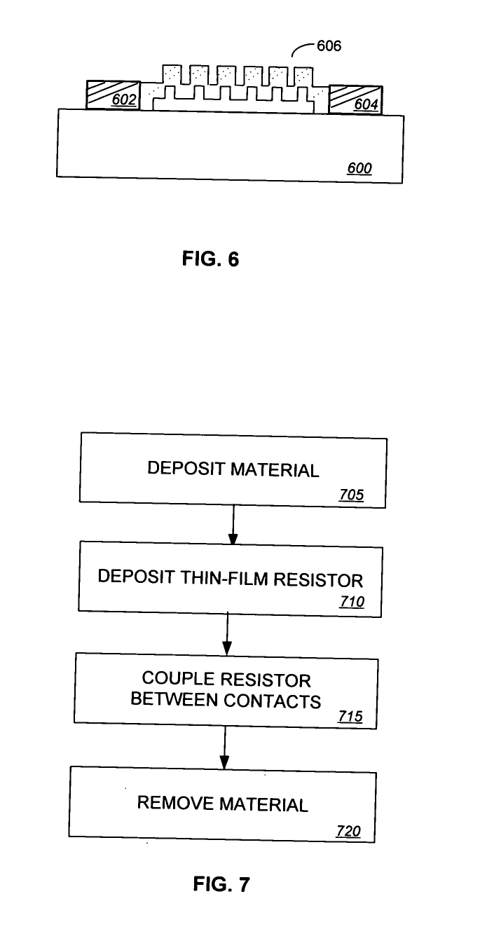

A third exemplary embodiment of a device that may be used to reduce resistor cracking is illustrated in FIG. 6. As shown in FIG. 7, the device may be produced by depositing 705 a material on a substrate 600. Next, a thin-film resistor 606 is deposited 710 on the material. The resistor is coupled 715 between a first contact 602 and a second contact 604. The material is then removed 720.

The thin-film resistor may be a ceramic resistor (e.g., tantalum nitride) or a metallic resistor (e.g., molybdenum or tungsten). By way of example, it may be deposited on the material by spin-coating, patterning, or other method. It should be appreciated that the resistor may be coupled to the contacts during or after the depositing 710.

The material may be removed by etching or other type of method to remove the material. As illustrated in FIG. 6, this causes a corrugated area to be defined between the resistor 606 and the substrate 600. It should be appreciated that in alternate embodiments, the material may not have been a corrugated material and thus the area defined between the resistor and the substrate may not be corrugated.

The thin-film resistor 606 may be used to generate heat. As the resistor heats up, the area between the resistor and the substrate 600 grants the resistor more independence from the compressive forces applied to it during the heating process. When the resistor starts to cool and contract, the area also allows the resistor greater freedom from the still hot substrate, thus reducing the tensile stresses on the resistor.

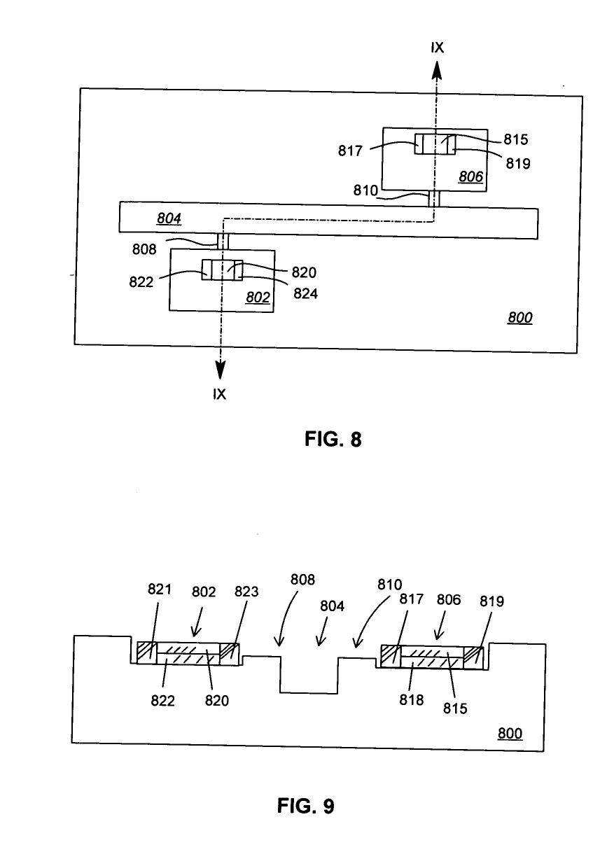

In one embodiment, the thin-film resistor may be part of a fluid-based switch, such as a liquid metal micro switch (LIMMS). An exemplary embodiment of a substrate that could be used in such a switch is illustrated in FIGS. 8 and 9.

A substrate 800 includes a switching fluid channel 804, a pair of actuating fluid channels 802, 806, and a pair of channels 808, 810 that connect corresponding ones of the actuating fluid channels 802, 806 to the switching fluid channel 804. It is envisioned that more or fewer channels may be formed in the substrate, depending on the configuration of the switch in which the substrate is to be used. For example, the pair of actuating fluid channels 802, 806 and pair of connecting channels 808, 810 may be replaced by a single actuating fluid channel and single connecting channel.

A compliant material 822 is deposited on the substrate 800 at a location within the actuating fluid channel 802. A thin-film 820 resistor is then deposited on the compliant material and coupled between a first contact 821 and a second contact 823. A similar configuration of compliant material 818, thin-film resistor 815, and contacts 817, 819 is located with actuating fluid channel 806.

As will be described in more detail below, the thin-film resistors 818, 820 may be used to heat an actuating fluid. The compliant materials 818, 822 may reduce the amount of compressive stresses and tensile stresses experienced by their respective resistors during the heating and cooling process. It should be appreciated that in alternate embodiments, the compliant material may be corrugated and/or removed as described with reference to FIGS. 4, 5, and 6.

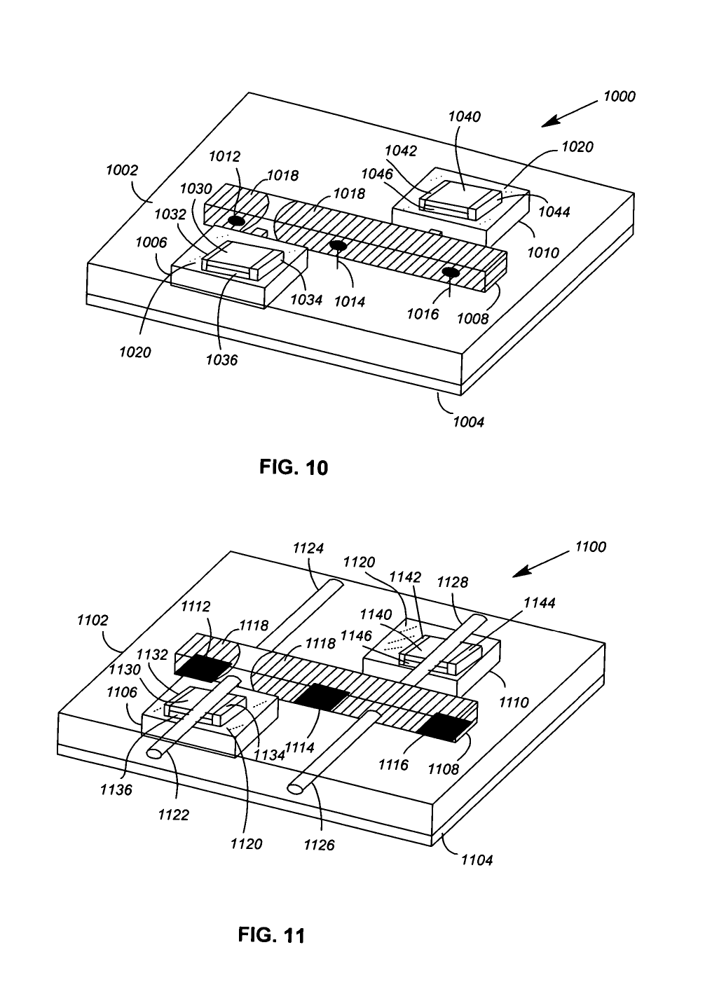

FIG. 10 illustrates a first exemplary embodiment of a switch 1000. The switch 1000 comprises a first substrate 1002 and a second substrate 1004 mated together. The substrates 1002 and 1004 define between them a number of cavities 1006, 1008, and 1010. Exposed within one or more of the cavities are a plurality of electrodes 1012, 1014, 1016. A switching fluid 1018 (e.g., a conductive liquid metal such as mercury) held within one or more of the cavities serves to open and close at least a pair of the plurality of electrodes 1012-1016 in response to forces that are applied to the switching fluid 1018. An actuating fluid 1020 (e.g., an inert gas or liquid) held within one or more of the cavities serves to apply the forces to the switching fluid 1018.

A thin-film resistor 1030 (such as a ceramic resistor) is deposited on a compliant material 1036 (such as polyimide) and is coupled between first and second contacts 1032, 1034. The thin-film resistor 1030 is located within actuating fluid cavity 1006. A similar configuration between thin-film resistor 1042, compliant material 1046, and contacts 1042 and 1044 is located in actuating fluid cavity 1010. As illustrated, the compliant materials 1036, 1046 are deposited on substrate 1004. It should be appreciated that in alternate embodiments, the compliant material may be deposited on substrate 1002.

In alternate embodiments, the compliant materials 1036, 1046 may be corrugated and/or made of a composition that results in a weak bond being formed between the compliant materials 1036, 1046 and their respective thin-film resistors 1030, 1040. Additionally, the compliant materials may be etched away to define an area between their respective thin-film resistor 1030, 1040 and the substrate 1004. It should be appreciated that if the compliant materials are etched away, then the materials need not be compliant (i.e., they could be non-compliant).

In one embodiment of the switch 1000, the forces applied to the switching fluid 1018 result from pressure changes in the actuating fluid 1020. The pressure changes in the actuating fluid 1020 impart pressure changes to the switching fluid 1018, and thereby cause the switching fluid 1018 to change form, move, part, etc. In FIG. 10, the pressure of the actuating fluid 1020 held in cavity 1006 applies a force to part the switching fluid 1018 as illustrated. In this state, the rightmost pair of electrodes 1014, 1016 of the switch 1000 are coupled to one another. If the pressure of the actuating fluid 1020 held in cavity 1006 is relieved, and the pressure of the actuating fluid 1020 held in cavity 1010 is increased, the switching fluid 1018 can be forced to part and merge so that electrodes 1014 and 1016 are decoupled and electrodes 1012 and 1014 are coupled.

By way of example, pressure changes in the actuating fluid 1020 may be achieved by means of heating the actuating fluid 720 with thin-film resistors 1030, 1040. This process is described in more detail in U.S. Pat. No. 6,323,447 of Kondoh et al. entitled “Electrical Contact Breaker Switch, Integrated Electrical Contact Breaker Switch, and Electrical Contact Switching Method”, which is hereby incorporated by reference for all that it discloses. Other alternative configurations for a fluid-based switch are disclosed in U.S. patent application Ser. No. 10/137,691 of Marvin Glenn Wong filed May 2, 2002 and entitled “A Piezoelectrically Actuated Liquid Metal Switch”, which is also incorporated by reference for all that it discloses. Although the above referenced patent and patent application disclose the movement of a switching fluid by means of dual push/pull actuating fluid cavities, a single push/pull actuating fluid cavity might suffice if significant enough push/pull pressure changes could be imparted to a switching fluid from such a cavity.

Additional details concerning the construction and operation of a switch such as that which is illustrated in FIG. 10 may be found in the aforementioned patent of Kondoh et al., and patent application of Marvin Wong.

As described elsewhere in this application, by depositing thin-film resistors 1030 and 1040 on compliant materials 1036 and 1046, the compressive and tensile stresses the resistors are subject to during the heating and cooling cycles may be reduced. Thus, the fatigue life of the thin-film resistors may be increased.

FIG. 11 illustrates a second exemplary embodiment of a switch 1100. The switch 1100 comprises a substrate 1102 and a second substrate 1104 mated together. The substrates 1102 and 1104 define between them a number of cavities 1106, 1108, 1110. Exposed within one or more of the cavities are a plurality of wettable pads 1112-1116. A switching fluid 1118 (e.g., a liquid metal such as mercury) is wettable to the pads 1112-1116 and is held within one or more of the cavities. The switching fluid 1118 serves to open and block light paths 1122/1124, 1126/1128 through one or more of the cavities, in response to forces that are applied to the switching fluid 1118. By way of example, the light paths may be defined by waveguides 1122-1128 that are aligned with translucent windows in the cavity 1108 holding the switching fluid. Blocking of the light paths 1122/1124, 1126/1128 may be achieved by virtue of the switching fluid 1118 being opaque. An actuating fluid 1120 (e.g., an inert gas or liquid) held within one or more of the cavities serves to apply the forces to the switching fluid 1118.

A thin-film resistor 1130 (such as a ceramic resistor) is deposited on a compliant material 1136 (such as polyimide) and is coupled between first and second contacts 1132, 1134. The thin-film resistor 1130 is located within actuating fluid cavity 1106. A similar configuration between thin-film resistor 1142, compliant material 1146, and contacts 1142 and 1144 is located in actuating fluid cavity 1110. As illustrated, the compliant materials 1136, 1146 are deposited on substrate 1104. It should be appreciated that in alternate embodiments, the compliant material may be deposited on substrate 1102.

In alternate embodiments, the compliant materials 1136, 1146 may be corrugated and/or made of a composition that results in a weak bond being formed between the compliant materials 1136, 1146 and their respective thin-film resistors 1130, 1140. Additionally, the compliant materials may be etched away to define an area between their respective thin-film resistor 1130, 1140 and the substrate 1104. It should be appreciated that if the compliant materials are etched away, other types of non-compliant materials may also be in place of the compliant material before the material is removed.

Forces may be applied to the switching and actuating fluids 1118, 1120 in the same manner that they are applied to the switching and actuating fluids 1018, 1020 in FIG. 10. By using a thin-film resistor device as described elsewhere in this application, the compressive and tensile stresses the resistors are subject to during the heating and cooling cycles may be reduced. Thus, the fatigue life of the thin-film resistors may be increased.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A device comprising:
a substrate;
first and second contacts, supported by and in direct contact with the substrate;
a compliant material deposited on the substrate; and
a thin-film heater resistor coupled between the first and second contacts and deposited on the compliant material so that the thin-film heater resistor forms a weak bond with the compliant material and at least partially delaminates from the compliant material as the thin-film heater resistor heats.

2. The device of claim 1, wherein the compliant material comprises a corrugated material.

3-4 (canceled)

5. The device of claim 1, wherein the compliant material comprises polyimide.

6. The device of claim 1, wherein the thin-film heater resistor comprises a ceramic heater resistor.

7. The device of claim 6, wherein the ceramic heater resistor comprises a tantalum nitride resistor.

8. The device of claim 1, wherein the thin-film heater resistor comprises one of molybdenum and tungsten.

9-23 (canceled)

24. A device comprising:
a substrate;
first and second contacts, supported by and in direct contact with the substrate;
a corrugated compliant material deposited on the substrate; and
a thin-film heater resistor coupled between the first and second contacts and deposited on the corrugated compliant material so that it contacts at least two ridges of the corrugated compliant material.

25. The device of claim 24, wherein the corrugated compliant material comprises a material that results in the thin-film heater resistor forming a weak-bond with the corrugated compliant material so that the thin-film heater resistor at least partially delaminates from the corrugated compliant material as the thin-film heater resistor heats.

26. The device of claim 24, wherein the corrugated compliant material comprises polyimide.

27. The device of claim 24, wherein the thin-film heater resistor comprises a ceramic heater resistor.

28. The device of claim 27, wherein the ceramic heater resistor comprises a tantalum nitride resistor.

29. The device of claim 24, wherein the thin-film heater resistor comprises one of molybdenum and tungsten.

30. The device of claim 2, wherein the thin-film heater resistor is corrugated.

31. The device of claim 24, wherein the thin-film heater resistor is corrugated.
